(19) United States
(12) Patent Application Publication
(10) Pub. No.: US 2013/0105536 A1
(43) Pub. Date: May 2, 2013

(54) FLUSH MOUNTED CENTER CONSOLE CUP HOLDER

(71) Applicants: Scott Simon, Dexter, MI (US); Raymond Anthony Oldani, Canton, MI (US)

(72) Inventors: Scott Simon, Dexter, MI (US); Raymond Anthony Oldani, Canton, MI (US)

(73) Assignee: Ford Global Technologies, LLC, Dearborn, MI (US)

(21) Appl. No.: 13/283,982

(22) Filed: Oct. 28, 2011

(51) Int. Cl. B60R 11/00

(52) U.S. Cl. 224/567

(57) ABSTRACT

A cup holder assembly for use in a console of a motor vehicle comprises a housing and a support assembly, wherein the support assembly has a top surface that is deployable in a multi-stage configuration to provide multiple depths as required by the vehicle user. The top surface of the support assembly is further configured to be flush with the vehicle console when in a fully extended position and a cup holder is not required.

### FIELD OF THE INVENTION

The present invention generally relates to a cup holder assembly for use in a console of a motor vehicle and, more specifically, a cup holder assembly disposed on a vehicle console, wherein the cup holder assembly is deployable between depressed and extended positions.

### BACKGROUND OF THE INVENTION

Vehicles often have fixed cup holders disposed in the console for storing beverages and other items for the vehicle occupants. However, in vehicles with higher interior trim level designs, there is a desire to conceal the cup holders when not in use to provide a clean, finished appearance of the console. In the past, doors that flip or slide over fixed cup holders have been used to conceal the cup holders when not in use. The present invention provides a deployable cup holder assemblies that are disposed in a console of a vehicle and configured such that the cup holder assemblies have support assemblies with top surfaces which are flush with the console when the support assemblies are in the extended position, thereby concealing the cup holder, and further wherein the support assemblies can be depressed using a latch and dampening device to provide a functioning cup holder in the console.

### SUMMARY OF THE INVENTION

According to one aspect of the present invention, a deployable cup holder assembly for an angled vehicle console comprises a housing adapted to sliadably receive a support assembly. The support assembly includes a top surface with a planar portion for providing a substantially flat support surface relative to the angled console. The support assembly is operable between a depressed position and a fully extended position, and a dampening device is operably coupled to the support assembly to dampen vertical movement of the support assembly.

Another aspect of the present invention includes a deployable cup holder assembly for a vehicle console comprises a housing and a support assembly slideably received in the housing, wherein the support assembly is operable between a depressed position and an extended position. The support assembly includes a top surface having a substantially horizontal planar portion for providing a flat support surface when the support assembly is in the depressed position. A damper device is coupled to the support assembly to dampen vertical movement of the support assembly.

Yet another aspect of the present invention includes a deployable cup holder assembly for a vehicle console comprises a housing and a support assembly slideably received in the housing which is operable between a depressed position and an extended position. The support assembly further includes a top surface disposed on the support assembly having a downwardly angled portion relative to the console. A plurality of damper devices are coupled to the housing and the support assembly and a latch mechanism is incorporated for retaining the support assembly in the depressed position.

These and other aspects, objects, and features of the present invention will be understood and appreciated by those skilled in the art upon studying the following specification, claims, and appended drawings.

### BRIEF DESCRIPTION OF DRAWINGS

In the drawings:

FIG. 1 is a perspective view of a cup holder assembly according to one embodiment of the present invention;

FIG. 1A is a perspective view of a cup holder assembly in a partially depressed position;

FIG. 1B is a perspective view of a cup holder assembly in a fully depressed position;

FIG. 2 is a perspective view of another embodiment of a pair of cup holder assemblies as found in a vehicle console;

FIG. 2A is a perspective view of a pair of cup holder assemblies as found in a vehicle console in a depressed position;

FIG. 2B is a cross-sectional view of a pair of cup holder assemblies as found in a vehicle console; and

FIG. 3 is an exploded perspective view of a cup holder assembly.

### DETAILED DESCRIPTION OF THE PREFERRED EMBODIMENTS

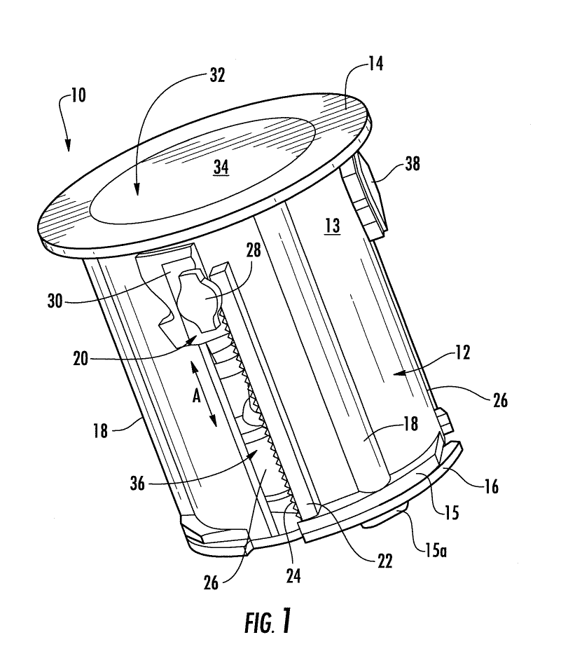

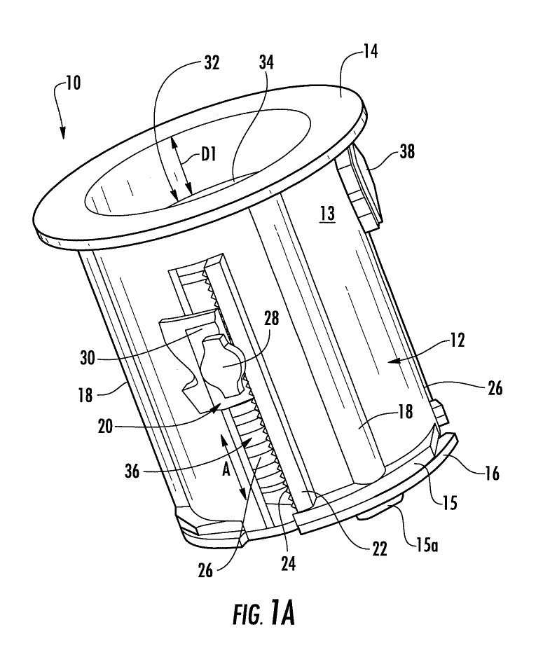

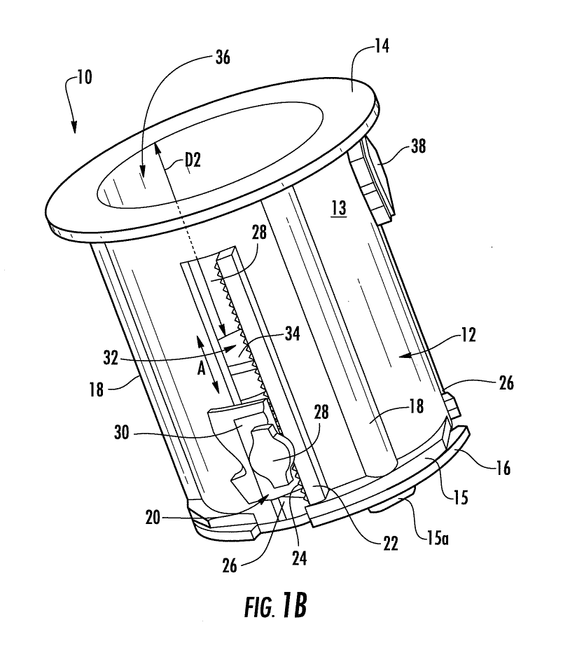

For the purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in following specification, are simply exemplary embodiments. Hence, specific dimensions and other physical characteristics relating to the embodiments disclosed herein are not to be construed as limiting, unless expressly stated otherwise.

Referring to FIG. 1, the reference numeral 10 generally designates a deployable cup holder assembly according to one embodiment of the present invention. The cup holder assembly 10 includes a cup holder assembly housing 12 having a generally cylindrical body portion 13 with an upper portion of the cylindrical body 13 connected to a rim 14 and a lower portion of the cylindrical body 13 having a lower flange 15 coupled to a base assembly 16 by clip members 15a. The housing 12 further comprises anti-rotational ribs 18, which, as shown in FIG. 1, extend from the rim 14 to the lower flange 15 of housing 12 and are designed to bolster the structural integrity of the housing 12 as well as prevent rotation of the housing 12 in deploying the cup holder. The housing 12 further comprises slots 26 which are used to house a dampening system 20 or a guide assembly 38, as further described below. The slots 26 are generally disposed in the embodiment of FIG. 1 in 120° increments around the cylindrical body portion 13 of the housing 12.

Slideably received within the housing 12 is a support assembly 32 having a top surface 34. The support assembly 32 can be moved vertically within a housing interior 36 defined by the cylindrical body portion 13 of housing 12. The support assembly 32 generally moves vertically within the housing 12 from a fully extended position, as shown in FIG. 1, where the top surface 34 of the support assembly 32 is substantially flush with the rim 14 of the housing 12 to a recessed, depressed, or deployed position, wherein the top surface 34 of the support assembly 32 is pushed by the user toward the lower portion of the housing 12. When in the fully extended or undeployed position, the support assembly 32 is substantially flush with a vehicle console so as to conceal the cup holder assembly 10 when not in use.

The dampening or damper system 20, as shown in FIG. 1, is disposed within a housing slot 26 and comprises a platform 30 upon which a geared dampening wheel 28 is disposed. The housing 12 further comprises a toothed bar 22 located adjacent the housing slot 26. The toothed bar 22 includes a row of teeth 24, which are disposed on a side of the toothed bar 22 directly adjacent the housing slot 26 and adapted to engage the geared dampening wheel 28 in assembly. In operation, as the user of the cup holder assembly 10 presses on the top surface 34 of the support assembly 32, the platform 30, which is operably coupled to the support assembly 32 about a top surface sidewall (not shown), moves vertically downward within the housing slot 26 in a direction indicated by arrow A. As the platform 30 moves vertically in the direction of arrow A, the geared dampening wheel 28 also moves vertically along the toothed bar 22 of the housing 12 and rotates as the teeth (not shown) of the geared dampening wheel 28 engage the row of teeth 24 disposed on the toothed bar 22. In this way, the dampening system 20 dampers the vertical movement of the support assembly 32 as it moves within the interior 36 of the housing 12. As shown in FIG. 1, the dampening system is coupled to the support assembly 32 and disposed on the exterior of the body portion 13 of the housing 12. In this way, the dampening device 20 is located outside of the range of motion of the support assembly 32, such that the support assembly 32 can be vertically moved to a depth that is not limited by a dampening device being disposed directly underneath the support assembly 32. This configuration results in a space savings that is of value in interior console design as space is limited. A viscous dampening system, as shown herein, is commercially available at Illinois Tool Works (ITW) Motion, Inc. of Frankfort, Ill.

As shown in FIG. 1, a guide 38 is operably coupled to a top surface sidewall (not shown) of the support assembly 32. In operation, the guide 38 controls the movement of the support assembly 32 vertically within the interior 36 of the housing 12. It is also contemplated that a second dampening system can be disposed at the location of the guide 38 within the housing slot 26 for providing a system having a plurality of dampers.

Referring now to FIG. 1A, a cup holder assembly 10 is shown with an associated support assembly 32 being depressed into the interior 36 of the housing 12. As shown in FIG. 1A, the user of the cup holder assembly 10 has pressed the top surface 34 down to a depth as indicated by arrow D1. The user of the cup holder assembly 10 can depress the top surface 34 using the base of the beverage to be stored, or by using their fingers to latch the top surface in the depressed position. As further shown in FIG. 1A, the dampening system 20 has moved vertically within the housing slot 26 in the direction indicated by arrow A to a mid-depth position. A latching mechanism (not shown) is operably coupled to the support assembly 32 and is adapted to retain the support assembly 32 in the depressed as described below.

Referring now to FIG. 1B, the cup holder assembly 10 is shown with the support assembly 32 in a fully depressed position as indicated by arrow D2 which is contemplated to be approximately 80 mm into the housing 12. In this deployed or depressed position, the top surface 34 of the support assembly 32 shown in FIG. 1B is positioned to support a beverage, coins, cell phone and other chattel the vehicle user may wish to store in the deployed cup holder assembly 10. It is contemplated that a latch system coupled to the support assembly 32 can be used to retain the depression depth of the support assembly 32 and retain the support assembly 32 in either the first or second depressed position, and the latch system includes a latch mechanism such as a push-push latch mechanism known in the art.

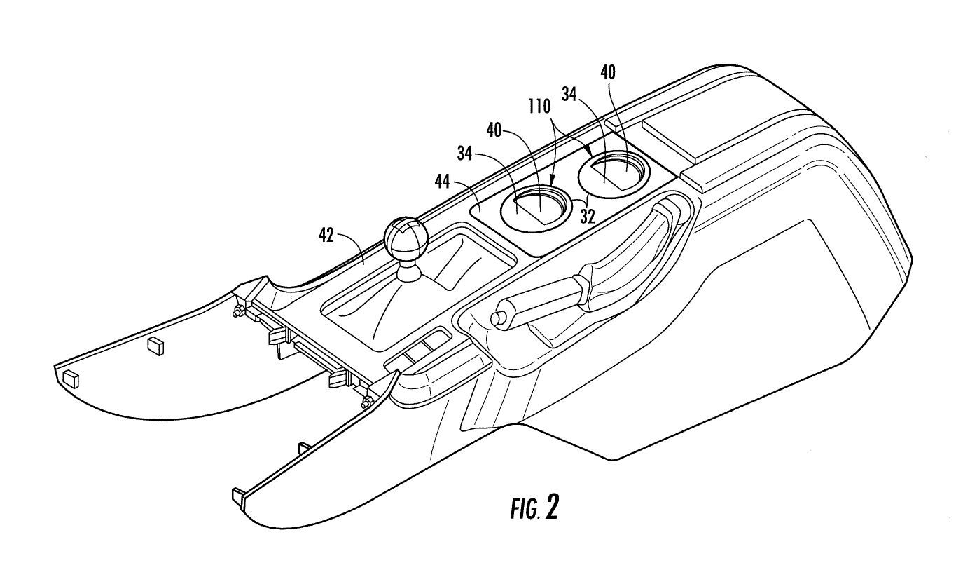

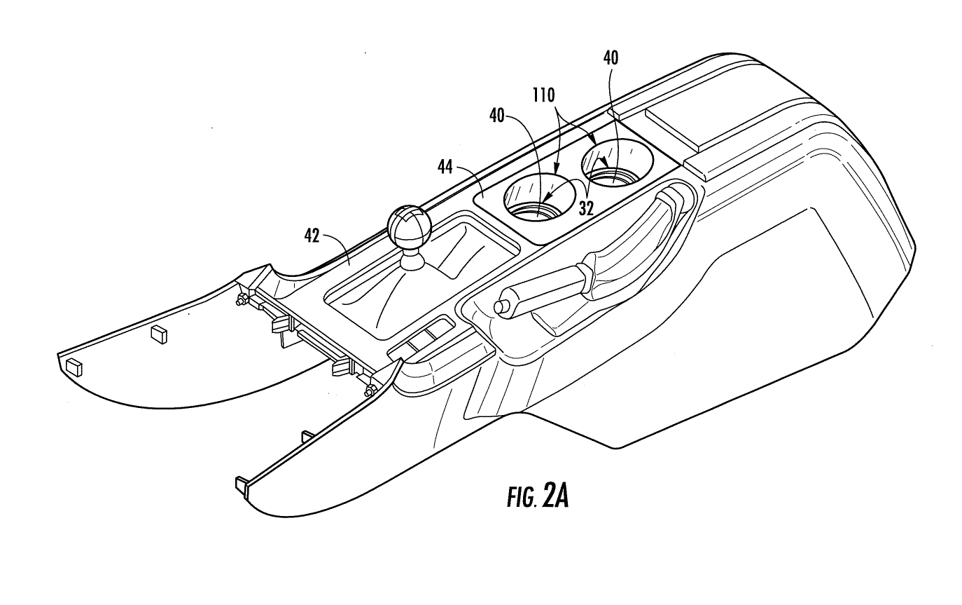

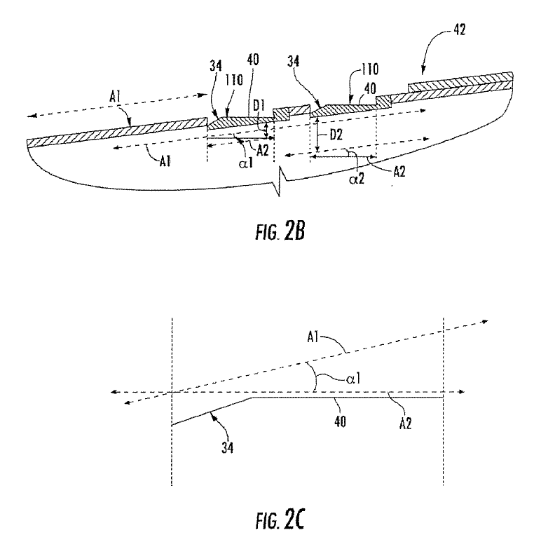

Referring now to FIG. 2, two embodiments of a cup holder assembly 110 are shown disposed in an angled vehicle console 42. The embodiments shown in FIG. 2 are similar to the cup holder assembly 10 shown in FIG. 1, however, the embodiments shown in FIG. 2 do not have a rim disposed around the top surfaces 34 of the support assemblies 32, but rather have a finish panel 44 in which the cup holder assemblies 110 are disposed. In this configuration, the top surfaces 34 of the cup holder assemblies 110 are substantially flush with the finish panel 44 disposed on the vehicle console 42 when in a fully extended position, as shown in FIG. 2. When the top surfaces 34 of the cup holder assemblies 110 are substantially flush with the finish panel 44, the cup holders are relatively concealed within the finished look of the console when a functional cup holder assembly is not desired. Further, the cup holder assemblies 110, as shown in FIG. 2, have flat or planar portions 40 disposed on the top surface 34 of the cup holder assemblies 110, which have angles that correlate to an angle of the angled console 42 as further described in the description of FIGS. 2B and 2C. The cup holder assemblies 110, as shown in FIG. 2, operate in a manner similar to that of the cup holder assembly 10 shown in FIG. 1, such that the user can press down on the top surface 34 of the support assembly 32 to create a storage space for a beverage or other item. As shown in FIG. 2, the top surfaces 34 of the support assemblies 32 are substantially flush with the top finish panel 44 to present a clean flowing appearance when a cup holder is not required. When the vehicle occupant wishes to deploy the cup holder assemblies 110, the vehicle occupant will push down on the top surface 34 of a select support assembly 32, and latch the cup holder assembly 110 into the depressed position, such as that shown in FIG. 2A.

As shown in FIG. 2B, the vehicle console 42 has a generally upward angled plane as viewed from left-to-right and indicated by arrows A1. The top surfaces 34 of the cup holder assemblies 110 have an angled portion 34a and a flat or planar portion 40, as shown in FIG. 2C. The flat or planar portions 40 have a horizontal configuration as shown by the substantially horizontal plane indicated by arrow A2. Thus, the planar portion 40 of the top surface 34 of the support assembly 32 makes for a partially and downwardly angled top surface relative to the console as indicated by α1 and α2. In this way, the planar portions 40 of the support surfaces 34 provide for a substantially flat support surface for a beverage when the cup holder assembly 110 is in a depressed position as shown in FIG. 2B. The angles α1 and α2, therefore, correlate to the relative angled plane of the console, as indicated by arrows A1, such that, regardless of the console angle, the top surfaces 34 of the cup holder assemblies 110 can have a planar portion 40, such that a beverage is maintained in a fully upright position when stored in the cup holder assembly 110. FIG. 2C is a cross-sectional view of the top surface 34 of a cup holder assembly 110 showing correlating angles between the angled portion 34a of the cup holder assembly, the planar portion 40, and the console. As shown in FIGS. 2B and 2C, the angled portion 34a of the top surface 34 is configured to substantially match the angle of the console as indicated by arrows A1. In this way, the angled portion 34a of the top surface 34 helps to conceal the cup holder in the console when the cup holder assembly 110 is in the fully extended position such as when a functional cup holder is not desired.

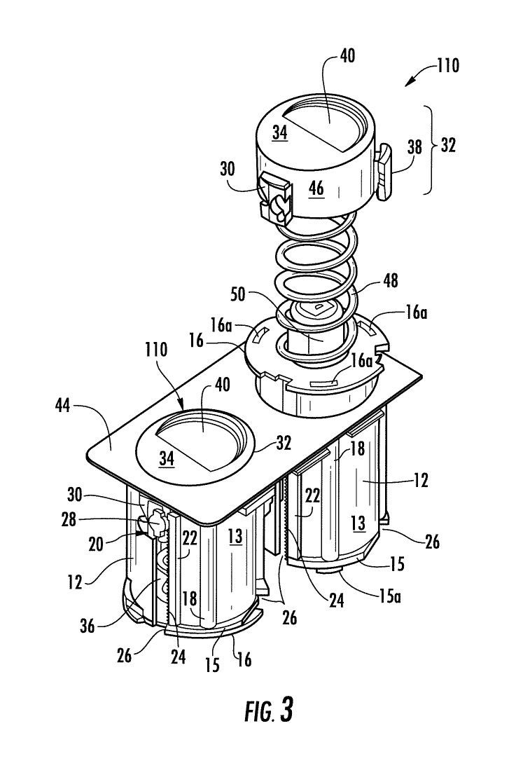

Referring now to FIG. 3, the cup holder assemblies 110 are shown as disposed in finish panel 44, wherein the rear cup holder assembly 110 has the support assembly 32 removed from its housing 12 in an exploded view. The removed support assembly 32 shows the top surface 34 having a flat portion 40 and a supporting sidewall 46 to which the platform 30 of the dampening system 20 and the support assembly guide 38 are coupled. In assembly, the dampening system platform 30 and the support assembly guide 38 are disposed within the housing slots 26 of the housing 12 as the support assembly 32 moves vertically within the interior 36 of the housing 12. The support assembly 32 is operably coupled to the base assembly via a biasing mechanism as shown in FIG. 3 in the form of a biasing spring 48. In operation, the biasing spring 48 urges the support assembly 32 to the fully extended position, such that, as the support assembly 32 is released from the latch mechanism, the support assembly 32 will be urged vertically upward in a dampened manner until the top surface 34 is substantially flush with the finish panel 44. The base assembly 16 connects to the lower flange 15 of the housing 12 via clip projections 15a disposed on the lower flange 15 of the housing 12. In assembly, the clip projections 15a correspond to apertures 16a disposed on the base assembly 16. The biasing spring 48 is coupled to the support assembly 32 and is also coupled to the base assembly 16 at a cylindrical connection body 50, which is covered by the top surface supporting side wall 46 of the support assembly 32 when the support assembly 32 is in a fully depressed position.

As further shown in FIG. 3, the top surface 34 of the cup holder assemblies 110 has a planar portion 40 which is configured to resemble a piston crown having a valve relief. Valve reliefs are notches on the crown of a piston that provide clearance for intake and exhaust valves. The overall configuration of the top surface 34 resembles a high performance piston crown with a deep and large diameter valve relief exemplified by the planar portion 40 of the top surface 34.

It is to be understood that variations and modifications can be made on the aforementioned structure without departing from the concepts of the present invention, and further it is to be understood that such concepts are intended to be covered by the following claims unless these claims by their language expressly state otherwise.

We claim:

1. A deployable cup holder assembly for an angled vehicle console comprising:
a housing;
a support assembly slideably received in the housing, having a top surface with an angled portion and a planar portion for providing a substantially flat support surface relative to the angled console;
the support assembly operable between a depressed position and an extended position; and
a dampening device operably coupled to the support assembly to dampen movement of the support assembly.

2. A cup holder assembly as set forth in claim 1, including:
a push-push latching mechanism coupled to the support assembly and operable to retain the support assembly in the depressed position.

3. A cup holder assembly as set forth in claim 1, wherein:
the housing comprises a generally cylindrical body portion having anti-rotational ribs for keeping the housing in place during movement of the support assembly.

4. A cup holder assembly as set forth in claim 3, wherein:
cylindrical body portion further comprises housing slots disposed thereon for coupling the dampening device to an exterior of the housing.

5. A cup holder assembly as set forth in claim 1, including:
a biasing mechanism coupled to the support assembly and the housing for biasing the support assembly to the extended position.

6. A cup holder assembly as set forth in claim 1, wherein:
the top surface is substantially flush with the vehicle console when the support assembly is in the extended position.

7. A deployable cup holder assembly for a vehicle console comprising:
a housing;
a support assembly slideably received in the housing and operable between depressed and extended positions, wherein the support assembly includes a top surface having an angled portion and a substantially horizontal planar portion for providing a flat support surface in the depressed position; and
a damper device coupled to the support assembly and an exterior of the housing to dampen support assembly movement.

8. A cup holder assembly as set forth in claim 7, including:
a latch system coupled to the support assembly and operable to retain the support assembly in the depressed position.

9. A cup holder assembly as set forth in claim 8, wherein:
the latch system comprises a push-push latching mechanism.

10. A cup holder assembly as set forth in claim 7, wherein:
the housing comprises a generally cylindrical body portion having anti-rotational ribs for keeping the housing in place during movement of the support assembly.

11. A cup holder assembly as set forth in claim 7, including:
a biasing mechanism coupled to the support assembly and the housing for biasing the support assembly to the extended position.

12. A cup holder assembly as set forth in claim 11, wherein:
the biasing mechanism comprises a spring.

13. A cup holder assembly as set forth in claim 7, wherein:
the top surface is substantially flush with the vehicle console when the support assembly is in the extended position.

14. A deployable cup holder assembly for a vehicle console comprising:
a housing;
a support assembly slideably received in the housing and operable between depressed and extended positions;
a top surface disposed on the support assembly having a downwardly angled portion relative to the console; and
a plurality of damper devices coupled to an exterior of housing and the support assembly having a latch mechanism for retaining the support assembly in the depressed position.

15. A cup holder assembly as set forth in claim 14, wherein:
the latch mechanism comprises a push-push latching mechanism.

16. A cup holder assembly as set forth in claim 14, wherein:
the housing comprises a generally cylindrical body portion having anti-rotational ribs for keeping the housing in place during movement of the support assembly.

17. A cup holder assembly as set forth in claim 14, including:
a biasing mechanism coupled to the support assembly and the housing for biasing the support assembly to the extended position.

18. A cup holder assembly as set forth in claim 14, wherein:
the top surface is configured to resemble a piston crown having a valve relief.

19. A cup holder assembly as set forth in claim 14, wherein:
the top surface is substantially flush with the vehicle console when the support assembly is in the extended position.

20. A cup holder assembly as set forth in claim 14, wherein:
the housing further comprises an exterior having slots in which a support assembly guide is disposed for guiding vertical movement of the support assembly.
